(19) United States
(12) Patent Application Publication
(10) Pub. No.: US 2011/0267413 A1
(43) Pub. Date: Nov. 3, 2011

(54) MEDIUM TRANSPORT ROLLER, RECORDING APPARATUS, AND METHOD OF MANUFACTURING MEDIUM TRANSPORT ROLLER

(75) Inventors: Yosuke NAKANO, Shiojiri-shi (JP); Eiji TAKETSUGU, Shiojiri-shi (JP)

(73) Assignee: SEIKO EPSON CORPORATION, Tokyo (JP)

(21) Appl. No.: 13/098,204

(22) Filed: Apr. 29, 2011

(30) Foreign Application Priority Data
Apr. 30, 2010 (JP) 2010-105277

(51) Int. Cl. B41J 2/01; B65H 5/06

(52) U.S. Cl. 347/104; 492/37

(57) ABSTRACT

In a recording apparatus that performs the recording on a medium to be recorded, a transport driving roller as a medium transport roller taking charge of the transportation of the medium to be recorded is formed by machining a plate material in a cylindrical shape. On its outer peripheral surface, in a transport region adjoining a piece of paper, through holes are formed to penetrate in a thickness direction of a hollow shaft. Thus paper powder attached to the paper is introduced from the through hole into the inner portion of the hollow shaft and is discharged through the hole to a lower portion of the hollow shaft. Consequently, it is possible to prevent the paper powder from being reattached or scattered to the paper without separately providing a special component, thus preventing or suppressing the paper powder from being attached to the recording head.

### CROSS REFERENCE TO RELATED APPLICATIONS

This application claims the benefit of Japanese Application No. 2010-105277 filed on Apr. 30, 2010, which application is incorporated by reference in its entirety.

### BACKGROUND

1. Technical Field

The present invention relates to a medium transport roller which takes charge of the transportation of a medium to be recorded such as paper in a recording apparatus represented by a facsimile, a printer or the like, and a recording apparatus including the same. Furthermore, the invention relates to a method of manufacturing the medium transport roller.

2. Related Art

In a recording apparatus represented by a facsimile, a printer or the like, at an upstream side of a recording unit that performs the recording on a medium to be recorded, a transport unit is provided which transports the medium to be recorded. As a configuration of the transport unit, although there is a transport belt and the like which transports the medium to be recorded while adsorbing the same, the transport unit is generally constituted by a pair of rollers that are rotated while pinching and pressing the medium to be recorded therebetween.

In addition, although, as a configuration of the roller, there is an elastic roller and the like formed of a rubber or the like, particularly, in an ink jet printer, as shown in JP-A-2001-63862 and JP-A-2001-158544, a shaft-shaped roller with a high frictional layer formed on a surface of a metal shaft is used. Furthermore, the high frictional layer is formed by holding abrasion resistant particles on an outer peripheral surface of a shaft body by an adhesive layer, and performs a function of improving a fictional coefficient between the high frictional layer and the medium to be recorded to prevent slippage.

Incidentally, paper powder generated when paper is cut to a predetermined size is attached to the paper in some cases, and when the paper powder is attached to the ink jet recording head, the paper powder directly blocks up a nozzle opening or the paper powder is moved to the nozzle opening upon cleaning (wiping) a nozzle surface, which sometimes causes dot missing.

Furthermore, in a case where no paper powder measures are devised in the recording apparatus, when the paper powder is attached to a medium transport roller, the paper powder is dispersed due to the rotation of the roller or the paper powder is attached to the paper again and is dispersed from the paper, which causes the above disadvantage.

However, in order to remove the paper powder of the paper, when separately providing, for example, a paper powder removal unit that comes into contact with the paper to scrape the paper powder, a paper powder suction unit or the like, complexity in the apparatus and an increase in cost are caused.

### SUMMARY

An advantage of some aspects of the invention is to provide a medium transport roller that can prevent the dispersion of the paper powder or a reattachment thereof to the paper and can suppress the complexity of the recording apparatus and the increase in cost.

According to a first aspect of the invention, there is provided a medium transport roller that takes charge of transportation of a medium, wherein, in a hollow shaft that has a medium transport region coming into contact with the medium on an outer peripheral surface thereof, a plurality of through holes is provided which penetrates in a thickness direction of the medium transport region.

According to the aspect, since the medium transport roller taking charge of the transportation of the medium is configured so that the plurality of through holes penetrating in the thickness direction of the hollow shaft in the medium transport region coming into contact with the medium on the outer peripheral surface thereof is provided, the paper powder attached to the medium is introduced from the through hole into an inner portion of the hollow shaft and is discharged to a lower portion of the hollow shaft through the through hole. As a result, it is possible to prevent the reattachment of the paper powder to the medium or the dispersion thereof without separately providing a special component.

According to a second aspect of the invention, in the first aspect, inlets of the through holes are expanded toward the outside of the roller.

According to the second aspect, since the inlets of the through holes are expanded toward the outside of the roller, the paper powder can be satisfactorily attracted into the roller, and there is no need to enlarge a diameter of the through hole over the whole region in the length direction (the diameter direction of the roller) of the through hole, and thus, decline in strength of the entire roller can be suppressed.

According to a third aspect of the invention, in the first aspect, protrusions formed upon forming the through holes are included at edges of the through holes, the protrusions being protruded to an inner peripheral surface of the hollow shaft.

According to the third aspect, since the through hole is a punch hole that is bored from one side surface of a plate material toward the other side surface thereof, a burr-shaped protrusion is formed in an edge of the though hole in the other side surface. When the burr-shaped protrusion exists on the outer periphery surface of the roller, the medium may be damaged. However, in the present aspect, since the plate material is machined in a cylindrical shape so that the surface, on which the burr-shaped protrusion is not formed, becomes the outer peripheral surface of the roller, the above disadvantage can be obviated.

According to a fourth aspect of the invention, in the first aspect, the through holes are scattered in the medium transport region.

According to the fourth aspect, since the through holes are scattered in the medium transport region, it is possible to suitably and effectively introduce the attached paper powder into the roller.

According to a fifth aspect of the invention, there is provided a recording apparatus which includes a recording unit that performs the recording on a medium, the recording apparatus including the medium transport roller according to the first aspect. According to the fifth aspect, in the recording apparatus, the same working effect as the first aspect can be obtained.

According to a sixth aspect of the invention, in the fifth aspect, in an upstream side of the recording unit on a transport route of the medium, a medium transport unit including the medium transport roller and a driven roller coming into contact with the medium transport roller is included, wherein, when the skew of the medium is corrected by bringing a front end of the medium into contact with the medium transport roller or a portion between the medium transport roller and the driven roller, a mode of bringing the front end into contact with the through hole can be carried out.

According to the sixth aspect, since the recording apparatus is configured so that it can carry out the mode of correcting the skew of the medium by bringing the front end of the medium into contact with the medium transport roller or the portion between the medium transport roller and the driven roller, it is possible to effectively remove the paper powder attached to the medium front end via the through hole by carrying out the skew correction mode.

According to a seventh aspect of the invention, in the fifth aspect, a medium reversal unit is included which reverses the medium passed through the medium transport roller and causes the reversed medium to reach the upstream of the medium transport roller again, and before carrying out the recording on the medium, the medium is reversed by the medium reversal unit and a surface coming into contact with the through hole is recorded.

According to the seventh aspect, the recording apparatus includes a medium reversal unit which reverses the medium passed through the medium transport roller and causes the reversed medium to reach the upstream of the medium transport roller again, and, before carrying out the recording on the medium, the medium is reversed by the medium reversal unit, and a surface coming into contact once with the medium transport roller is recorded. Thus, the surface to be recorded comes into contact with the through hole of the medium transport roller once, whereby the paper powder is removed, which can effectively prevent the dispersion of the paper powder, particularly the dispersion thereof to the recording unit side.

According to an eighth aspect of the invention, in the fifth aspect, before recording the medium, the medium is delivered by the medium transport roller immediately until coming out of the medium transport roller, and then the medium transport roller is reversed and the medium is positioned in a feeding position, thereby bringing the medium into contact with the through hole.

According to the eighth aspect, the recording apparatus delivers the medium by the medium transport roller immediately until the medium comes out of the medium transport roller before recording the medium, and then reverses the medium transport roller and positions the medium in a feeding position. Thus, at least before the recording is started, the paper powder is removed over almost the entire region of the surface coming into the medium transport roller in the medium, whereby the dispersion of the paper powder can be effectively prevented.

According to a ninth aspect of the invention, in the fifth aspect, the recording unit includes a recording head that carries out the recording while being moved in a direction orthogonal to the transport direction of the medium, and the recording head retreats to a position not facing the medium when at least the medium passes through the arrangement position of the recording head in the transport direction from when the feeding of the medium is started to when the medium is positioned in the recording starting position.

According to the ninth aspect, since the recording head retreats to a position not facing the medium when at least the medium passes through the arrangement position of the recording head in the transport direction from when the feeding of the medium is started to when the medium is positioned in the recording starting position, it is possible to effectively suppress the paper powder from being attached to the recording head.

According to a tenth aspect of the invention, there is provided a method of manufacturing a medium transport roller that takes charge of the transportation of a medium, the method including boring a punch hole from one side surface of a plate material toward the other side surface thereof, and machining the plate material in a cylindrical shape so that a surface, on which the punch hole is bored, becomes an outer peripheral surface.

According to the tenth aspect, since the method includes boring a punch hole from one side surface of the plate material toward the other side surface thereof, and machining the plate material in a cylindrical shape so that a surface, on which the punch hole is bored, becomes an outer peripheral surface, it is possible to obtain the same working effects as the first aspect and the second aspect by the obtained medium transport roller.

### BRIEF DESCRIPTION OF THE DRAWINGS

The invention will be described with reference to the accompanying drawings, wherein like numbers reference like elements.

FIG. 1 is a side cross-sectional schematic view of a paper transport route of a printer according to the invention.

FIG. 2 is a side cross-sectional schematic view of a paper transport route of a printer according to the invention.

FIG. 3 is a cross-sectional perspective view of a paper guidance member and a transport driving roller.

FIG. 4A is a plan view of a completion state of the transport driving roller.

FIG. 4B is a plan view of a deployed state of the roller before cylinder machining.

FIG. 5A is a cross-sectional view in which a plate material of the transport driving roller before the cylinder machining is cut in a portion of the through hole.

FIG. 5B is a cross-sectional view after the cylinder machining.

FIG. 6A is a flow chart that shows the contents of the recording operation.

FIG. 6B is a flow chart that shows another embodiment of the recording operation.

### DESCRIPTION OF EXEMPLARY EMBODIMENTS

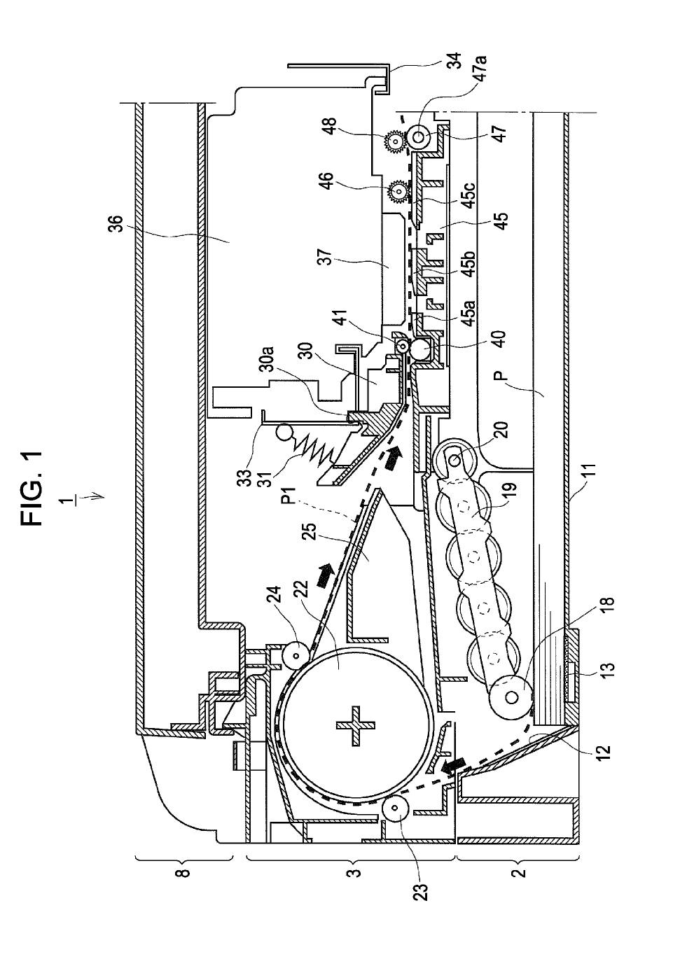

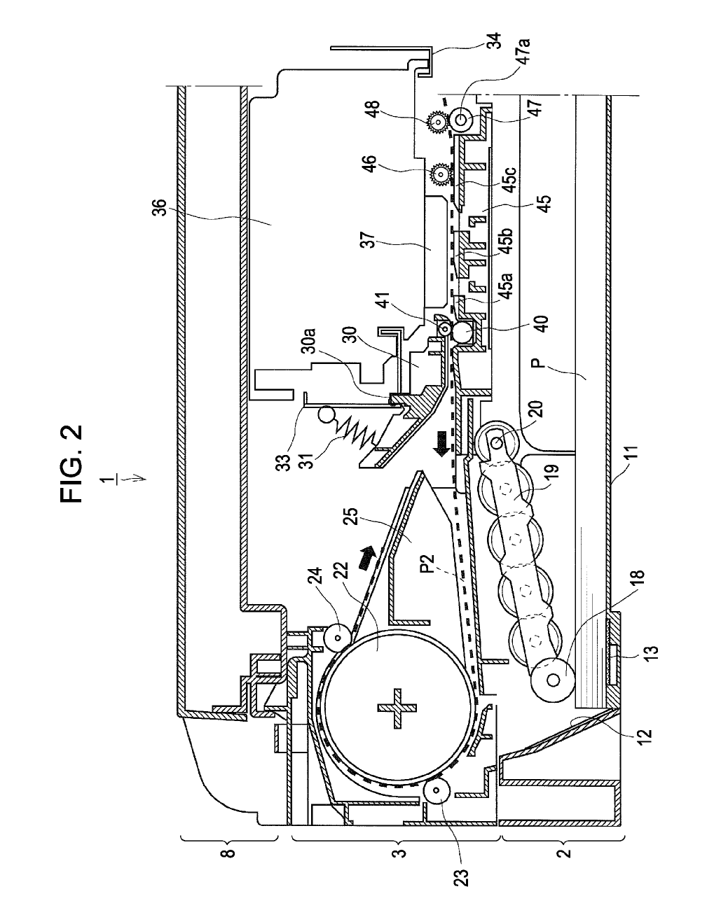

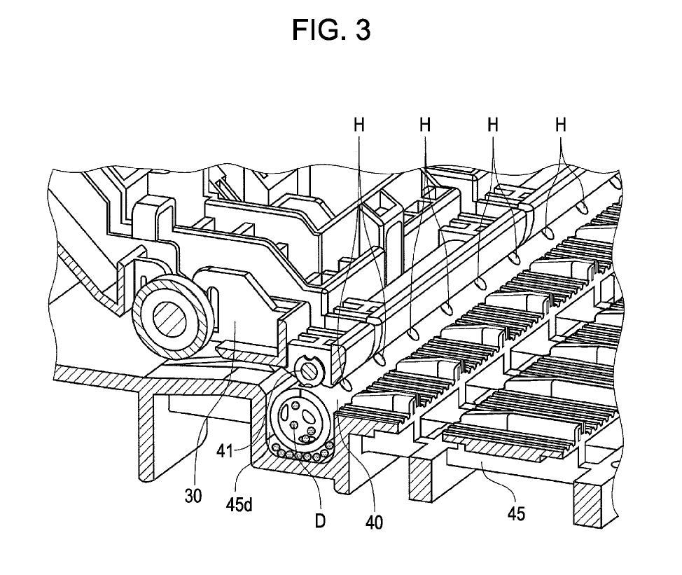

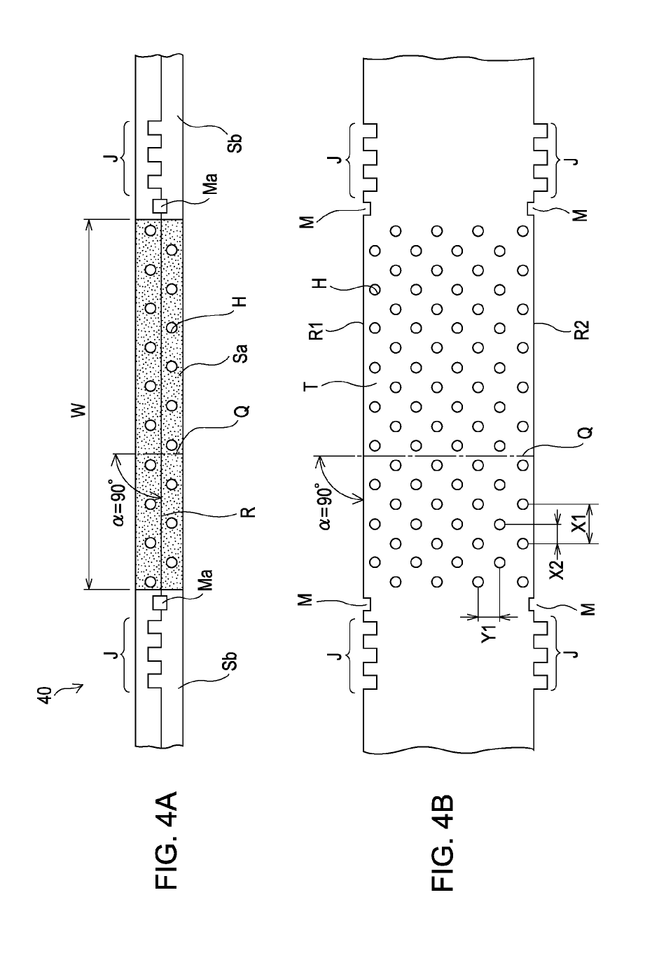

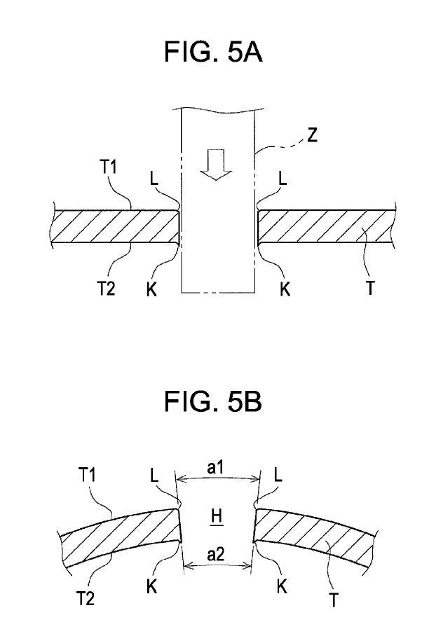

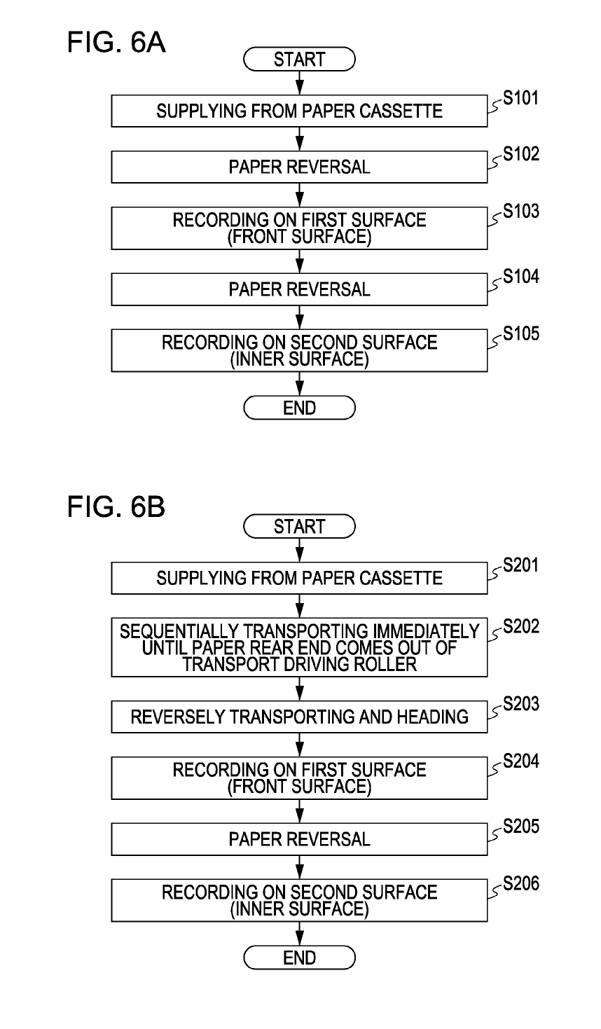

Hereinafter, an embodiment of the invention will be descried with reference to FIGS. 1 to 6B. Herein, FIGS. 1 and 2 are side cross-sectional views that show a paper transport route of an ink jet printer 1 as an example of a recording apparatus according to the invention. FIG. 3 is a cross-sectional perspective view of a paper guidance member 30 and a transport driving roller 40. FIG. 4A is a plan view of a completion state of the transport driving roller 40. FIG. 4B is a plan view of a deployed state of the roller before cylinder machining. FIG. 5A is a cross-sectional view in which a plate material of the transport driving roller 40 before the cylinder machining is cut in a portion of the through hole. FIG. 5B is a cross-sectional view after the cylinder machining. FIG. 6A is a flow chart that shows the contents of the recording operation. FIG. 6B is a flow chart that shows another embodiment of the recording operation.

Hereinafter, in FIGS. 1 and 2, a right direction of the drawings on a paper transport route from a middle roller 24 to a discharge driving roller 47 is referred to as a “downstream side” of the paper transport route, and a left direction of the drawings is referred to as an “upstream side”.

In FIG. 1, the ink jet printer 1 includes a paper feeding portion 2 in an apparatus bottom portion and includes a configuration in which a recording paper P as an example of a medium to be recorded is delivered from the paper feeding portion 2, bent and reversed by a paper transport roller unit 3, and is fed to the side of the recording unit (an ink jet recording head 37), thereby performing the recording. Furthermore, in FIG. 1, dotted lines P1 show a transport route (a passage trace) of the recording paper P of this time.

Furthermore, the ink jet printer 1 is configured so that, after recording a first surface (a front surface) of the recording paper P, it back feeds and transports the paper to the transport roller unit 3, reverses the paper and turns a second surface (a back surface) thereof over to become the upper side, and can transport the paper to the side of the ink jet recording head 37 again. That is, the ink jet printer 1 is configured so as to enable double-sided recording to be performed, and dotted lines P2 in FIG. 2 show a transport route (a passage trace) of the recording paper P of this time.

Reference numeral 8 shows a scanner unit that is provided in an upper portion of a printer mechanism portion, and the ink jet printer 1 is configured as a so-called combiner that can print and output a manuscript image read by the scanner unit 8 by a lower printer mechanism portion.

Hereinafter, a configuration of the paper transport route will be described in detail. The paper feeding portion 2 includes a paper cassette 11 and a feeding roller 18. In the paper cassette 11 that can be attached to and detached from a printer apparatus main body, an edge guide (not shown) is provided, a side end position and a rear end position of the recording paper P accommodated in the paper cassette 11 are restricted by the edge guide.

In a position that faces the front end of the recording paper P accommodated in the paper cassette 11, a separation slope surface 12 is provided, and the front end of the recording paper P to be delivered by the feeding roller 18 is fed to the downstream side while coming into slide contact with the separation slope surface 12, whereby the uppermost recording paper P to be fed is separated from the next recording papers P that are attracted thereto and are prone to be moved together.

The feeding roller 18 is pivotally supported on an oscillation member 19 that can oscillate around an oscillation shaft 20 in a clockwise rotation direction and a counterclockwise rotation direction of FIGS. 1 and 2, and is provided so as to be rotated and driven by the power of a driving motor (not shown). The feeding roller 18 comes into contact with the uppermost piece of the recording paper P accommodated in the paper cassette 11 and is rotated when feeding the paper, thereby delivering the uppermost recording paper P from the paper cassette 11.

Furthermore, a frictional pad 13 is provided in a position facing the feeding roller 18 in the paper cassette 11, and when the feeding roller 18 presses and contacts the paper bundle from the upper side, the lowermost recording paper P is pressed toward the frictional pad 13, thereby performing a function of holding the paper bundle so that the delivery is not performed for each paper bundle.

The recording paper P delivered from the paper cassette 11 to the upper side enters the paper transport roller unit 3. The paper transport roller unit 3 includes a reversal roller 22, middle rollers 23, 24 and a guide member 25, which constitute a paper reversal unit.

The reversal roller 22 is a large-diameter roller that forms the inside of a route which bends and reverses the recording paper P, and in the present embodiment, one reversal roller is disposed in a center position in a paper width direction (both sides paper direction of FIGS. 1 and 2), that is, in a feeding standard position of the ink jet printer 1 according to the present embodiment (see FIG. 3). The reversal roller 22 is provided so as to be rotated and driven by the power of a driving motor (not shown), and transports the recording paper P to the downstream side by being rotated in the clockwise rotation direction of FIGS. 1 and 2.

The middle rollers 23 and 24 are freely rotatable rollers and assist the paper transportation by the reversal roller 22 by nipping the recording paper P between them and the reversal roller 22. The guide member 25 is situated between the reversal roller 22 and the transport driving roller 40 and forms an upper route, and a lower route through which the recording paper P recorded on a first surface thereof passes upon being back fed.

Next, at the downstream side of the middle roller 24, a first transport unit including a transport driving roller 40 and a transport driven roller 41 is provided. The transport driving roller 40 is formed by the attachment of the abrasion resistant particles to the surface of a long shaft body in the paper width direction in the present embodiment and is rotated and driven by a driving motor (not shown). Furthermore, although the transport driving roller 40 is formed by a hollow shaft in which the metallic plate material is machined in a cylindrical shape in the present embodiment, this will be described later in detail.

Furthermore, in FIGS. 4 and 5, reference numeral Sa shows a high frictional region that is formed by the attachment of the abrasion resistant particles, and the high frictional region Sa becomes a region (a medium transport region) that comes into contact with the recording paper P. Furthermore, reference numeral W shows a formation range of the high frictional region Sa, reference numeral Sb shows a low frictional region in which the frictional resistant particles are not attached, respectively.

Returning to FIGS. 1 and 2, a plurality of transport driven rollers 41 is formed by a resin material in the present embodiment and is disposed along the longitudinal direction of the transport driving roller 40. The transport driven roller 41 is pivotally supported on a paper guidance member 30 as a roller supporter in a freely rotatable manner and is provided so as to be pressed to and contact the transport driving roller 40, thereby nipping the recording paper P between the transport driven roller 41 and the transport driving roller 40.

The paper guidance member 30 supporting the transport driven roller 41 is supported by a frame 33 via an oscillation shaft 30a in an oscillatable manner, and is provided in the state in which the transport driven roller 41 is biased in a direction of being pressed to and contacting the transport driving roller 40 by a tension spring 31 that exhibits a biasing force between the frame 33 and the paper guidance member 30.

Furthermore, the paper guidance member 30 performs a function of guiding the recording paper P, which is fed from the upstream side, to a nip point between the transport driving roller 40 and the transport driven roller 41 in addition to pivotally supporting the transport driven roller 41. Furthermore, the paper guidance member 30 also performs a function of guiding a paper rear end to the nip point between the transport driving roller 40 and the transport driven roller 41 when the recording paper P, the rear end of which is removed from the nip point between the transport driven roller 41 and the transport driving roller 40 to the downstream side (a right side in FIGS. 1 and 2), is back fed (transported to a left direction in FIGS. 1 and 2).

Next, at the downstream side of the transport driving roller 40, an ink jet recording head 37 and a paper guidance member 45 are oppositely disposed up and down. The ink jet recording head 37 is disposed on a bottom portion of a carriage 36, and the carriage 36 is provided so as to receive the power of a driving motor (not shown) and reciprocate in a main scanning direction (both side directions of paper in FIGS. 1 and 2) while being guided to the frames 33 and 34 disposed back and forth. Furthermore, an ink cartridge (not shown) is accommodated in the carriage 36.

On a surface of the paper guidance member 45 facing the ink jet recording head 37, ribs 45a, 45b and 45c extending in a paper transport direction are disposed from the upstream side of the paper transport direction toward the downstream side thereof in this order with predetermined gaps, and a plurality of respective ribs is provided in the main scanning direction with suitable gaps (the arrangement of the main scanning direction is not shown). The recording paper P is supported by the ribs and the distance between the recording paper P and the ink jet recording head 37 is regulated.

Next, in the downstream side of the region where the ink jet recording head 37 faces the paper guidance member 45, an assistance roller 46 preventing the paper floating is provided, and in the downstream side thereof, a discharge driving roller 47 and a discharge driven roller 48 are provided which constitute a second transport unit. The discharge driving roller 47 is formed by a rubber roller and is rotated and driven by a driving motor (not shown). The discharge driven roller 48 is a spur provided so as to lightly and elastically contact the discharge driving roller 47 and nips the recording paper P between the discharge driven roller 48 and the discharge driving roller 47. The recorded paper P is discharged toward a stacker (not shown) by these rollers.

Furthermore, the transport driving roller 40 can rotate in forward or rearward directions, that is, the transport driving roller 40 can transport the recording paper P in either direction of a first direction (a right direction in FIGS. 1 and 2: a downstream side direction) through which the recording paper P is transported to the side of the ink jet recording head 37 and a second direction (a left direction in FIGS. 1 and 2: an upstream side direction) through which the recording paper P is transported to the side of the paper transport roller unit 3 having a reversal route. Furthermore, the discharge driving roller 47 can similarly rotate in forward and rearward directions, whereby the recording paper P can be transported in any direction of the first direction and the second direction.

The above is a configuration of the paper transport route of the ink jet printer 1, and the transport driving roller 40 as the medium transport roller will be described in detail with reference to FIGS. 3 to 6B.

The transport driving roller 40 is formed by machining the metallic plate material in a cylindrical shape in the present embodiment as mentioned above, and mainly includes press machining of the metallic plate material, punching machining (described later) that is performed at the time of the press machining or separately from the press machining to form a through hole H, cylinder machining of the obtained plate material, and machining of attaching the abrasion resistant particles to the surface of a cylindrical shaft that was obtained by the cylinder machining. Hereinafter, firstly, a pull-out shape upon performing the press machining of the metallic plate material will be described in detail. Furthermore, in regard to the cylinder machining, for example, a machining method described in JP-A-2006-289496 can be adopted.

FIG. 4A is a plan view of the transport driving roller 40, reference numeral R shows a joint portion in a transport region W, reference numeral Q shows a circumference line (an imaginary straight line: which is parallel to the paper transport direction). Furthermore, reference numeral J shows a jig saw portion, and reference numeral Ma shows a matching hole, respectively. Moreover, the transport driving roller 40 can be obtained by bending machining the plate material T shown in FIG. 4B in a cylindrical shape. In FIG. 4B, reference numeral M shows the matching, and reference numerals R1 and R2 show a pair of end portions of the plate material T that forms the transport region W after the cylinder machining.

As shown in FIG. 4B, the end portions R1 and R2 are extended in a straight line shape so as to form a right angle) (α=90°) with respect to a circumference line Q and are formed in a smooth straight line in which a concave portion, a convex portion or the like are not absolutely formed. As a result, the joint portion R after the cylinder machining is also extended in a straight line shape so as to form a right angle (α=90°) with respect to a circumference line Q, as shown in FIG. 4A and becomes a smooth straight line in which concave and convex portions or the like are not absolutely formed.

The matching M formed during press machining is situated outside the transport region W and becomes a matching hole Ma by the opposition of the concave portion after the cylinder machining. The jig saw portion J is a convex and concave fitting portion to be formed for enhancing the joint strength and is formed in a state in which one side end portion of the plate material T is a concave shape and the other side end portion thereof is a convex shape so that the jig saw portion J is accurately fitted during joining. The transport driving roller 40 is adapted so that, particularly, the torsional strength is improved after the cylinder machining by the jig saw portion J, but the jig saw portion J is also situated outside the transport region W similarly to the matching hole Ma.

As mentioned above, according to the present embodiment, in the transport driving roller 40 formed by machining the plate material T in a cylindrical shape, since the transport region W at least adjoining the paper is extended in a straight line shape in a direction intersecting the circumference line Q and the matching hole Ma or the jig saw portion J is formed outside the transport region W, the joint portion R, in which the pair of end portions R1 and R2 of the plate material T are joined to each other can reduce or prevent the paper front end from being hooked to the outer peripheral surface of the transport driving roller 40, whereby a smooth transportation can be secured.

Furthermore, by disposing the matching hole Ma and the jig saw portion J outside the region where they are pivotally supported by a bearing portion (not shown) pivotally supporting the transport driving roller 40, it is also possible to secure the smooth sliding movement between them and the inner peripheral surface of the bearing portion.

Next, in the transport region W, the through holes H penetrating in the plate thickness direction are formed so as to be scattered all over the region of the transport region W. More specifically, in the present embodiment, a plurality of rows of the through holes H formed in the axial direction (the paper width direction: left and right direction of FIGS. 4A and 4B) with a gap X1 in plural is formed with a gap Y1 in a direction (becoming the paper transport direction: up and down direction in FIGS. 4A and 4B) orthogonal to the axial direction and while the axial direction position is shifted by X2 (in the present embodiment, X2=X1/2). In other words, the through holes H are formed in a zigzag shape.

The size, the arrangement gap, the opening shape or the like of the through hole H can be suitably set in view of an attraction property of the paper powder described later and the strength of the whole transport driving roller 40. For example, it is possible to set the opening shape of the through hole H to a perfect circle of a diameter of 2 mm, the arrangement gap X1 of the axial direction to 10 mm, and the arrangement gap Y1 in the direction orthogonal to the axial direction to 45° gap when forming the cylinder (if the diameter of the transport driving roller 40 is d, Y1=π·d/8).

Herein, the through hole H can be formed by the punch machining before the cylinder machining, and, for example, as shown in FIG. 5A, the through hole H can be formed by punching the plate material T from the side of one side surface T1 thereof toward the other side surface T2 thereof using a boring punch Z.

At this time, a depression (shown by reference numeral K) called sagging is formed on the one side surface T1, and a burr-shaped protrusion (shown by reference numeral L) called a “burr” is formed on the other side surface T2. When the surface T2 formed with the burr-shaped protrusion L forms the roller outer peripheral surface of the roller, the burr-shaped protrusion L may damage the paper. Otherwise, a polishing process is separately necessary to remove the burr-shaped protrusion L. In the present embodiment, since the machining is performed so that the surface T2 becomes the inside when the plate T is subjected to the cylinder machining, an occurrence of the above disadvantage is prevented.

Furthermore, in the present embodiment, an inlet of the through hole H is formed so as to be expanded toward the outside of the roller, that is, so that an opening diameter a1 of the roller outside becomes larger than an opening diameter a2 of the roller inside. As a result, the paper powder can be satisfactorily attracted into the roller, and since there is no need to increase the diameter of the through hole H over the whole region in the length direction (the plate thickness direction in FIGS. 5A and 5B), the decline in strength of the whole roller can be suppressed.

As mentioned above, since, in the transport driving roller 40, the through holes H penetrating in the thickness direction of the hollow shaft are formed so as to be scattered in the transport region W adjoining the paper on the outer peripheral surface thereof, the paper powder (shown by reference numeral D in FIG. 3) attached to the paper is introduced from the through holes H into the inner portion of the hollow shaft (FIG. 3) and is discharged to the lower part of the hollow shaft through the through holes H. As a result, it is possible to prevent the reattachment or the dispersion of the paper powder to the paper without separately providing a special component, whereby it is possible to prevent or suppress the paper powder from being attached to the recording head 37.

Furthermore, although the opening shape of the through hole H was a perfect circle shape in the present embodiment, it is possible to adopt various shapes such as a polygonal shape or a star shape without being limited thereto. Furthermore, in FIG. 3, reference numeral 45d shows a paper powder receiving concave portion formed in the paper guidance member 45, and the paper powder D received in the inner portion of the transport driving roller 40 is dropped into the paper powder receiving concave portion 45d and is collected. However, such a paper powder receiving unit may not be formed integrally with the paper guidance member 45, but a separate tray-shaped paper powder receipt can be disposed under the transport driving roller 40.

However, the paper powder withdrawal effect by the transport driving roller 40 can be more effectively obtained by the control when the paper is fed. For example, by bringing the paper front end into contact with the transport driving roller 40, or the portion between the transport driving roller 40 and the transport driven roller 41 to carryout the skew removal mode of correcting the paper skew, the paper powder attached to the paper front end can be effectively removed via the through holes H.

As such as skew removal control, a so-called collision method or a bite discharge method can be adopted. For example, in the skew removal of the bite discharge method, the paper front end is delivered to the downstream side from the transport driving roller 40 by a predetermined amount, and then, the transport driving roller 40 is reversed in a state in which the paper transportation by the middle roller 22 is stopped. As a result, the paper P is bent between the middle roller 22 and the transport driving roller 40 and the paper front end follows the portion between the transport driving roller 40 and the transport driven roller 41, whereby the skew is removed. Moreover, at this time, the paper powder of the paper front end is removed.

Furthermore, it is also possible to effectively remove the paper powder by performing the control shown in FIGS. 6A and 6B. As an example, as shown in FIG. 6A, after feeding the paper from the paper cassette 11 (step S101), the ink jet printer 1 reverses the paper as shown in FIG. 2 without performing the printing as it is (step S102), and then carries out the recording on the first surface (the front surface) (step S103). Moreover, in the case of performing the recording on both sides of the paper, the ink jet printer reverses the paper again (step S104) and performs the recording onto the second surface (the back surface) (step S105).

That is, by reversing the paper before performing the recording on the paper, the surface to be recorded is necessarily brought into contact with the transport driving roller 40 once, whereby the paper powder is removed by the through hole H formed in the transport driving roller 40. Thus, as a result, it is possible to effectively prevent the dispersion of the paper powder, particularly, the dispersion of the paper powder from the surface facing the ink jet recording head 37 in the paper to the recording head 37 side.

Furthermore, as another embodiment, as shown in FIG. 6B, after feeding the papers from the paper cassette 11 (step S201), the paper is sequentially transported immediately until the paper rear ends deviate from transport driving roller 40 without performing the printing as it is (step S202), and then the paper is reversely transported, thereby performing the feeding of the paper (step S203).

Thereafter, the first surface (the front surface) is recorded (step S204), and when both sides of the paper are recorded, the paper is reversed (step S205) and the second surface (the back surface) is recorded (step S206).

As a result, at least before starting the recording, the paper powder is removed over almost the entire region of the surface coming into contact with the transport driving roller 40 in the paper, whereby the dispersion of the paper powder can be effectively prevented.

Furthermore, between the time after the feeding of the paper is started and until the paper is positioned in the recording starting position, at least while the paper passes the arrangement position of the recording head 37 in the transport direction, it is effective to cause the recording head 37 to retreat to a position where the recording head 37 does not face the paper. As a result, it is possible to effectively suppress the paper powder from being attached to the recording head 37.

The embodiment described above is an example and various modifications can be performed. Particularly, the above embodiment does not mean that the invention includes all of the aforementioned respective configurations, but, as long as at least the through holes H are included in the transport driving roller 40, it is possible to obtain the attraction effect of the paper powder by the through holes H into the inner portion of the roller.

In addition, although the hollow shaft is used in the transport driving roller 40 in the aforementioned embodiment, even in the hollow shaft obtained by other manufacturing methods without being limited to the hollow shaft obtained by the cylinder machining of the plate material as in the aforementioned embodiment, if the through holes H penetrating in the axial direction are formed, it is possible to obtain the attraction effect of the paper powder by the through holes H into the inner portion of the roller.

Furthermore, in the hollow shaft, a slit can be formed in addition to the through holes. In this manner, by forming the slit, the paper powder can be introduced into the inner portion of the roller via the slit and discharged to the lower portion of the roller via the slit, and thus, it is possible to prevent the paper powder from being reattached or scattered to the paper without separately providing a special component. Furthermore, when the slit is formed in the hollow shaft, the slit is formed so as to be penetrated in the thickness direction, and when the slit is formed in a solid shaft, the slit is formed so as to be penetrated in a diameter direction. Furthermore, as a formation of the slit, for example, the slit can be formed so as to be extended on the outer peripheral surface in a spiral shape.

What is claimed is:

1. A medium transport roller comprising:
a hollow shaft having a medium transport region coming into contact with a medium on an outer peripheral surface;
a plurality of through holes that is provided which penetrate in a thickness direction of the medium transport region in the hollow shaft.

2. The medium transport roller according to claim 1,
wherein inlets of the through holes are expanded toward the outside of the roller.

3. The medium transport roller according to claim 1,
wherein, protrusions formed upon forming the through holes are included at edges of the through holes, the protrusions being protruded into an inner peripheral surface of the hollow shaft.

4. The medium transport roller according to claim 1,
wherein the through holes are scattered in the medium transport region.

5. A recording apparatus which includes a recording unit that performs the recording on a medium,
wherein the recording apparatus includes the medium transport roller according to claim 1.

6. The recording apparatus according to claim 5, further comprising:
a medium transport unit which includes a medium transport roller and a driven roller coming into contact with the medium transport roller, at an upstream side of the recording unit on the transport route of the medium,
wherein, when a skew of the medium is corrected by bringing a front end of the medium into contact with the medium transport roller or a portion between the medium transport roller and the driven roller, a mode of bringing the front end into contact with the through hole can be carried out.

7. The recording apparatus according to claim 5, further comprising:
a medium reversal unit which reverses the medium passed through the medium transport roller and causes the reversed medium to reach the upstream of the medium transport roller again,
wherein, before carrying out the recording on the medium, the medium is reversed by the medium reversal unit and a surface coming into contact with the through hole is recorded.

8. The recording apparatus according to claim 5,
wherein, before recording the medium, the medium is delivered by the medium transport roller immediately until coming out of the medium transport roller, and then the medium transport roller is reversed and the medium is positioned in a feeding position, thereby bringing the medium into contact with the through hole.

9. The recording apparatus according to claim 5,
wherein the recording unit includes a recording head that carries out the recording while being moved in a direction orthogonal to the transport direction of the medium, and
wherein the recording head retreats to a position not facing the medium when at least the medium passes through an arrangement position of the recording head in the transport direction from when the feeding of the medium is started to when the medium is positioned in the recording starting position.

10. A method of manufacturing a medium transport roller that takes charge of transportation of a medium, the method comprising:
boring a punch hole from one side surface of a plate material toward the other side surface thereof; and
machining the plate material in a cylindrical shape so that a surface, on which the punch hole is bored, becomes an outer peripheral surface.
